(19) United States
(12) Patent Application Publication
(10) Pub. No.: US 2020/0274451 A1
(43) Pub. Date: Aug. 27, 2020

(54) POWER CONVERTER

(71) Applicant: Chicony Power Technology Co., Ltd., New Taipei City (TW)

(72) Inventors: Hsien-Yi Tsai, New Taipei City (TW); Bai-Song Que, New Taipei City (TW)

(21) Appl. No.: 16/446,401

(22) Filed: Jun. 19, 2019

(30) Foreign Application Priority Data
Feb. 26, 2019 (TW) 108106592

(51) Int. Cl. H02M 3/24; H02M 1/00

(52) U.S. Cl. CPC H02M 3/24; H02M 1/00

(57) ABSTRACT

A power convertor is configured to receive and convert an alternating current power into a direct current power and includes a detecting circuit and a level determining circuit. In the detecting circuit, two light emitting elements are connected together in parallel and in a reverse voltage direction, and then are connected in parallel with the AC power. The two light emitting elements are conducted during the positive half cycle and during the negative half cycle of the alternating current power, respectively. Two light receiving elements are connected together in parallel and in the same voltage direction, and then are connected between a power and the voltage divider. Each of the light receiving elements is conducted when its corresponding light emitting element is conducted, and the voltage divider provides a first voltage. A level determining circuit compares the first voltage with a reference voltage to selectively output an abnormal signal.

### CROSS-REFERENCE TO RELATED APPLICATION

This non-provisional application claims priority under 35 U.S.C. § 119(a) to Patent Application No. 108106592 filed in Taiwan, R.O.C. on Feb. 26, 2019, the entire contents of which are hereby incorporated by reference.

### BACKGROUND

### Technical Field

The present disclosure relates to a power converter apparatus, and particularly, to a power converter having a detecting circuit.

### Related Art

Currently, the way to detect a power state of an input voltage of a power supplier is to configure an optical coupler and a control circuit coupled to the optical coupler in a primary side of the power supplier. The optical coupler is configured to detect a power state of an input voltage, and the control circuit is configured to determine, according to the power state, whether the power supplier supplies power to a load. If the input voltage exists, the power supplier may supply power to the load; and if the input voltage does not exist, the power supplier may notify the load to perform preprocessing before a shutdown.

However, if the power state of the input voltage is powered off, but the optical coupler does not detect that the power state of the input voltage is powered off, the control circuit consequently misjudges that the power supplier supplies power to the load. For example, when the power state is powered on, an input voltage is an alternating current (AC) voltage, and has the amplitude during a positive half cycle and the amplitude during a negative half cycle. When the optical coupler is conducted in response to the amplitude during the positive half cycle, this optical coupler is not conducted in response to the amplitude during the negative half cycle or when the alternating current voltage is interrupted. If the alternating current voltage is interrupted during the positive half cycle, the power-off state can be timely detected because the optical coupler is not conducted. However, if the alternating current voltage is interrupted during the negative half cycle, the control circuit cannot determine that the optical coupler is not conducted whether because the alternating current voltage has amplitude for the negative half cycle or because the alternating current voltage is interrupted, and consequently, the control circuit cannot timely detect the power state is powered off, such that the control circuit delays notifying the load to perform preprocessing before a shutdown. Therefore, the control circuit cannot timely notify the load to perform preprocessing before the load shuts down when the alternating current voltage is interrupted during the negative half cycle.

### SUMMARY

In view of this, the present disclosure provide a power converter, configured to timely detect a power state of an alternating current (AC) power, and send an abnormal signal to an external control circuit when the power state is powered off, such that the external control circuit performs preprocessing for a load or an external electronic device before a load or an external electronic device shuts down.

According to some embodiments, the power converter includes a primary-side circuit, a transformer circuit, a detecting circuit, and a level determining circuit. The primary-side circuit is configured to receive and convert an alternating current power into a primary-side output, and the primary-side circuit has a first input end and a second input end. The transformer circuit is configured to receive the primary-side output. The detecting circuit includes a first isolation component, a second isolation component, a current limiting circuit, a voltage divider, and a capacitor. The first isolation component includes a first light emitting element and a first light receiving element. When the first light emitting element is conducted, the first light receiving element is conducted. When the first light emitting element is not conducted, the first light receiving element is not conducted. The second isolation component includes a second light emitting element and a second light receiving element. When the second light emitting element is conducted, the second light receiving element is conducted. When the second light emitting element is not conducted, the second light receiving element is not conducted. The first light emitting element and the second light emitting element are connected together in parallel and in a reverse voltage direction between a first antiparallel connection point and a second antiparallel connection point. The first antiparallel connection point is electrically connected to the first input end. The first light receiving element and the second light receiving element are connected in parallel and in a same voltage direction between a first parallel connection point and a second parallel connection point. The first parallel connection point is electrically connected to a direct current (DC) power. The current limiting circuit has two ends. The ends of the current limiting circuit are respectively electrically connected to the second antiparallel connection point and the second input end. The voltage divider has a first end, a voltage dividing point, and a second end. The first end of the voltage divider is electrically connected to the second parallel connection point. The capacitor is electrically connected to the first end of the voltage divider and the second end of the voltage divider. When the first light receiving element or the second light receiving element is conducted, the capacitor stores a capacitor voltage. When the first light receiving element and the second light receiving element are not conducted, the capacitor releases the capacitor voltage and generates a first voltage between the voltage dividing point and the second end. The level determining circuit has a first contact, a reference voltage, and an output end. The first contact receives the first voltage, and the level determining circuit compares the first voltage with the reference voltage to selectively output an abnormal signal from the output end.

According to some embodiments, the current limiting circuit includes: at least one resistor and at least one capacitor that are sequentially connected in series. An end of the resistor is electrically connected to the second antiparallel connection point, and an end of the capacitor is electrically connected to the second input end.

According to some embodiments, the voltage divider includes a first resistor and a second resistor that are sequentially connected in series. The first resistor and the second resistor that are connected in series are connected in parallel to the capacitor.

According to some embodiments, the level determining circuit includes: a front resistor and a comparing element. An end of the front resistor is connected to the direct current power, and the other end of the front resistor is connected to the comparing element. When the first voltage is less than the reference voltage, the comparing element enables the level determining circuit to output the abnormal signal. When the first voltage is not less than the reference voltage, the comparing element enables the level determining circuit not to output the abnormal signal.

The present disclosure additionally provides a power converter. The power converter includes a primary-side circuit, a transformer circuit, an isolation circuit, a coupling circuit, and a level determining circuit. The primary-side circuit has two input ends. The primary-side circuit is configured to receive an alternating current power from the two input ends, and rectify the alternating current power to output a primary-side output. The transformer circuit is configured to receive the primary-side output. The isolation circuit is connected in parallel to the two input ends. The isolation circuit is configured to detect a power state of the alternating current power. The isolation circuit transmits a conducting signal when the power state is powered on. The isolation circuit does not transmit the conducting signal when the power state is powered off. When the isolation circuit transmits the conducting signal, the isolation circuit is optically coupled to the coupling circuit, to enable the coupling circuit to generate a capacitor voltage. When the isolation circuit does not transmit the conducting signal, the isolation circuit is electrically isolated from the coupling circuit, to enable the coupling circuit to generate a first voltage by dividing the capacitor voltage. The level determining circuit has a reference voltage. The level determining circuit is configured to compare the first voltage with the reference voltage to selectively output an abnormal signal from the output end.

According to some embodiments, the isolation circuit includes a first light emitting element and a second light emitting element. The second light emitting element is connected in parallel to the first light emitting element in a reverse voltage direction.

According to some embodiments, the coupling circuit includes a first light receiving element, a second light receiving element, a capacitor, and a first resistor and a second resistor that are connected in series. The first light receiving element is optically coupled to the first light emitting element, and the first light emitting element and the first light receiving element are integrated into a first isolation component. The second light receiving element is connected in parallel to the first light receiving element in a same voltage direction. The second light receiving element is optically coupled to the second light emitting element, and the second light emitting element and the second light receiving element are integrated into a second isolation component. The capacitor is connected in series to the second light receiving element. The capacitor is configured to store the capacitor voltage. An end of the first resistor is connected to an end of the capacitor, and an end of the second resistor is connected to another end of the capacitor. When the capacitor releases the capacitor voltage, the capacitor voltage is divided by the first resistor and the second resistor, so that the second resistor generates the first voltage.

### BRIEF DESCRIPTION OF THE DRAWINGS

FIG. 1 shows a schematic block diagram of a circuit of a power converter according to some embodiments; and

FIG. 2 shows a schematic block diagram of a circuit of a power converter according to some embodiments.

### DETAILED DESCRIPTION

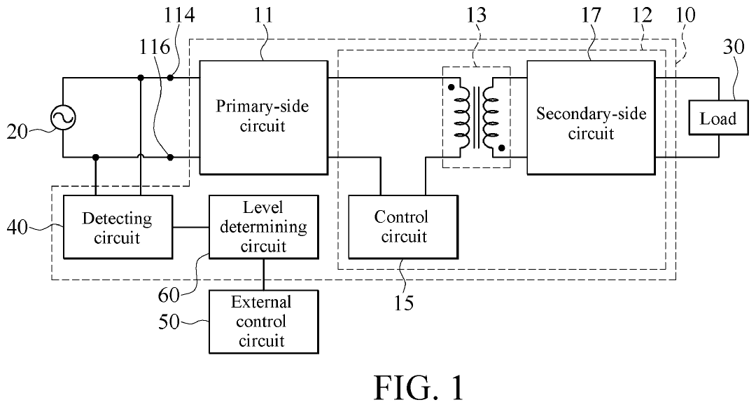

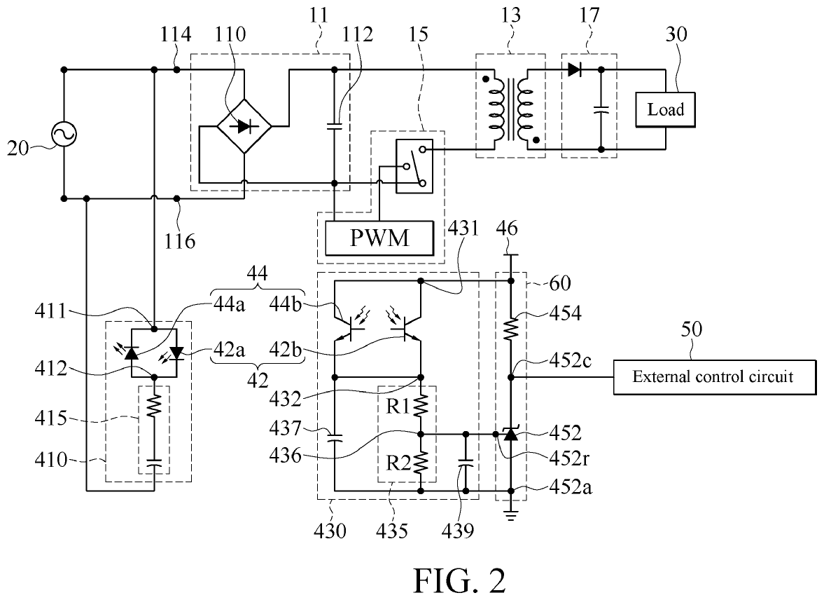

FIG. 1 shows a schematic block diagram of a circuit of a power converter 10 according to some embodiments of the present disclosure. FIG. 2 shows a schematic block diagram of a circuit of a power converter 10 according to some embodiments. The power converter 10 is configured to convert an alternating current (AC) power output by an alternating current power supplier (Alternating Power Supplier) 20 into a direct current (DC) power, and output the direct current power to a load 30. In addition, the power converter 10 may further detect its power state when receiving the alternating current power. When the power state is powered off, the power converter 10 outputs an abnormal signal to an external control circuit 50.

The alternating current power supplier 20 may be, but is not limited to, a mains grid. The load 30 may be, but is not limited to, any load such as an electronic apparatus, a mobile phone, a tablet computer, a computer, a desktop computer, or a notebook computer.

Referring to FIG. 1, the power converter 10 includes a primary-side circuit 11, a transformer circuit 12, a detecting circuit 40, and a level determining circuit 60. The transformer circuit 12 may be, but is not limited to, a flyback circuit (Flyback Converter), forward circuit (Forward Converter), a boost converter, or another transformer circuit. For example, the transformer circuit 12 is a flyback circuit, and the transformer circuit 12 includes a conversion circuit 13, a control circuit 15, and a secondary-side circuit 17, as shown in FIG. 1.

The primary-side circuit 11 has two input ends 114 and 116. The primary-side circuit 11 is configured to receive an alternating current power from the two input ends 114 and 116, and rectify the alternating current power to output a primary-side output. The transformer circuit 12 is configured to receive and convert the primary-side output to output a secondary-side output. In some embodiments, as shown in FIG. 1, the conversion circuit 13 is configured to receive the primary-side output. The conversion circuit 13 may be a winding shown in FIG. 1. The control circuit 15 is configured to control the conversion circuit 13 to generate a conversion output in response to the primary-side output. The secondary-side circuit 17 is configured to convert the conversion output into the secondary-side output to provide power required by the load 30. The secondary-side circuit 17 may be, but is not limited to, a half-wave rectifying filter circuit, as shown in FIG. 2.

In some embodiments, the primary-side circuit 11 includes a rectifier circuit 110 and a bulk capacitor 112, as shown in FIG. 2.

The detecting circuit 40 detects a power state of the alternating current power from the two input ends 114 and 116, and the detecting circuit 40 outputs a first voltage according to the power state. The power state, for example, is powered on or powered off. In some embodiments, the detecting circuit 40 outputs the first voltage according to the power state. The first voltage changes according to the power state. The detailed description is provided below. The level determining circuit 60 selectively outputs or does not output an abnormal signal according to the first voltage. Specifically, the level determining circuit 60 outputs the abnormal signal to the external control circuit 50 when the alternating current power is powered off. In some embodiments, the detecting circuit 40 and the level determining circuit 60 are appropriately adjusted, to enable the level determining circuit 60 to notify the external control circuit 50 within a time period before the secondary-side output decreases to a lower limit of power required by the load 30 (that is, the lowest power required for maintaining normal operation of the load 30), to help the external control circuit 50 timely send an alarm to the load (for example, an external electronic device) or perform preprocessing, such as saving a digital file that is currently not stored, on the load 30 before the load 30 shuts down. Herein, the detecting circuit 40 and the level determining circuit 60 of the power converter 10 are configured to detect power states of a positive half cycle and a negative half cycle of the alternating current power, and timely transmit the abnormal signal to the external control circuit 50 when the power state is powered off, that is, the power converter 10 may transmit the abnormal signal without delaying for a half-cycle period when the alternating current power is powered off. In some embodiments, the control circuit 15 controls a switch to be on or off by using a circuit with the Pulse Width Modulation (PWM) technology, so as to control the conversion output that is output by the conversion circuit 13.

Referring to FIG. 2, in some embodiments, the detecting circuit 40 includes a first isolation component 42 and a second isolation component 44. In some embodiments, the isolation element 56 may be, but is not limited to, an optical coupler.

The first isolation component 42 has a first light emitting element 42a and a first light receiving element 42b. The second isolation component 44 has a second light emitting element 44a and a second light receiving element 44b. The first isolation component 42 and the second isolation component 44 may be, but are not limited to, light coupling elements. When the first isolation component 42 works, the first light emitting element 42a is conducted, and the first light receiving element 42b is conducted. When the first light emitting element 42a is not conducted, the first light receiving element 42b is not conducted. When the second isolation component 44 works, the second light emitting element 44a is conducted, and the second light receiving element 44b is conducted, and when the second light emitting element 44a is not conducted, the second light receiving element 44b is not conducted.

Specifically, the first light emitting element 42a is configured to detect an amplitude during a positive half cycle of the alternating current power. The first light emitting element 42a is optically coupled to the first light receiving element 42b when the amplitude during the positive half cycle is detected. In addition, when the first light emitting element 42a does not detect the amplitude during the positive half cycle of the alternating current power, the first light emitting element 42a is electrically isolated from the first light receiving element 42b. The second light emitting element 44a is configured to detect the amplitude during the negative half cycle of the alternating current power, and is optically coupled to the second light receiving element 44b when the amplitude during the negative half cycle of the alternating current power is detected. In addition, when the second light emitting element 44a does not detect the amplitude during the negative half cycle of the alternating current power, the second light emitting element 44a is electrically isolated from the second light receiving element 44b. Therefore, the detecting circuit 40 may detect a power state of the alternating current power during the positive half cycle or during the negative half cycle. When the power state is powered off, the detecting circuit 40 transmits the signal representing the power state that is powered off (that is, an abnormal signal) to the external control circuit 50.

The detecting circuit 40 includes an isolation circuit 410 and a coupling circuit 430. The first light emitting element 42a and the second light emitting element 44a are disposed on the isolation circuit 410, and the first light receiving element 42b and the second light receiving element 44b are disposed on the coupling circuit 430. The isolation circuit 410 is connected in parallel to the two input ends 114 and 116, and the isolation circuit 410 detects the power state of the alternating current power. When the power state is powered on, the isolation circuit 410 transmits a conducting signal. When the power state is powered off, the isolation circuit 410 does not transmit the conducting signal. When the isolation circuit 410 transmits the conducting signal, the isolation circuit 410 is optically coupled to the coupling circuit 430, to enable the coupling circuit 430 to generate a capacitor voltage (a capacitor 437 of the coupling circuit 430 stores the capacitor voltage). When the isolation circuit 410 does not transmit the conducting signal, the isolation circuit 410 is electrically isolated from the coupling circuit 430, to enable the coupling circuit 430 to generate a first voltage at a voltage dividing point 436 by dividing the capacitor voltage. It is additionally noted that when the isolation circuit 410 transmits the conducting signal, the coupling circuit 430 generates the capacitor voltage, and the voltage dividing point 436 of the voltage divider 435 has the first voltage according to the capacitor voltage.

The level determining circuit 60 has a reference voltage. The level determining circuit 60 compares the first voltage with the reference voltage to selectively output an abnormal signal to the external control circuit 50. In some embodiments, when the first voltage is less than the reference voltage, the level determining circuit 60 outputs an abnormal signal to the external control circuit 50. When the first voltage is not less than the reference voltage, the level determining circuit 60 does not output the abnormal signal to the external control circuit 50.

The isolation circuit 410 includes the first light emitting element 42a and the second light emitting element 44a that are connected in parallel and in a reverse voltage direction, and a current limiting circuit 415. Two opposite ends of the second light emitting element 44a have a first antiparallel connection point 411 and a second antiparallel connection point 412, and the first antiparallel connection point 411 is electrically connected to one of the two input ends (for example, a first input end 114). An end of the current limiting circuit 415 is electrically connected to the second antiparallel connection point 412, and the other end of the current limiting circuit 415 is electrically connected to the other of the two input ends (for example, a second input end 116). In addition, the current limiting circuit 415 includes at least one resistor and at least one capacitor that are sequentially connected in series. An end of the resistor is electrically connected to the second antiparallel connection point 412, and an end of the capacitor is electrically connected to the second input end 116.

The isolation circuit 410 receives an alternating current power from alternating current power supplier 20. When the alternating current power supplier 20 outputs the amplitude during the positive half cycle of the alternating current power, the first light emitting element 42a emits light, and therefore, the first light receiving element 42b is conducted. When the alternating current power supplier 20 outputs the amplitude during the negative half cycle of the alternating current power, the second light emitting element 44a emits light, and therefore, the second light receiving element 44b is conducted. When the first light emitting element 42a and the second light emitting element 44a emit light, a capacitor of the current limiting circuit 415 stores electric energy. The stored electric energy is discharged when the voltage of the capacitor is higher than the voltage of the alternating current power output by the alternating current power supplier 20. When the alternating current power supplier 20 is suddenly interrupted, the capacitor of the current limiting circuit 415 performs discharging, and its discharging time is related to properties of the capacitor and the resistor of the current limiting circuit 415. If a product of a capacitance of the capacitor and an impedance of the resistor is higher, its discharging time is longer. When the capacitor performs discharging and its voltage is sufficient to conduct the first or second light emitting element 42a or 44a, the first or second light emitting element 42a or 44a emits light, and the corresponding first or second light receiving element 42b or 44b is conducted. In some embodiments, a relatively small product of the capacitance of the capacitor and the impedance of the resistor is selected, and the detecting circuit 40 may, within a relatively short time, detect that the alternating current power supplier 20 has been powered off (that is, power supplying is stopped). In embodiments, a relatively large product of the capacitance of the capacitor and the impedance of the resistor is selected, and it takes a relatively long time for the detecting circuit 40 to detect that the alternating current power supplier 20 has been powered off.

The coupling circuit 430 includes the first light receiving element 42b and the second light receiving element 44b that are connected together in parallel and in a same voltage direction, a voltage divider 435, and a capacitor 437. Two ends of the second light receiving element 44b have a first parallel connection point 431 and a second parallel connection point 432, and the first parallel connection point 431 is electrically connected to a direct current power 46. In addition, the second parallel connection point 432 is electrically connected to an end of the voltage divider 435, and the other end of the voltage divider 435 is grounded. The voltage divider 435 additionally has a voltage dividing point 436. An end of the capacitor 437 is electrically connected to the second parallel connection point 432, and the other end of the capacitor 437 is grounded. To be specific, the capacitor 437 and the voltage divider 435 are connected together in parallel. Therefore, when the first light receiving element 42b or the second light receiving element 44b is conducted, the capacitor 437 stores a capacitor voltage. When the first light receiving element 42b and the second light receiving element 44b is not conducted, the capacitor 437 releases the capacitor voltage to the voltage divider to generate the first voltage at the voltage dividing point 436.

The voltage divider 435 includes a first resistor R1 and a second resistor R2 that are connected in series. An end of the first resistor R1 is electrically connected to an end of the capacitor 437 (that is, the second parallel connection point 432), and an end of the second resistor R2 is electrically connected to the other end of the capacitor 437 (that is, a ground). When the capacitor 437 releases the capacitor voltage, the capacitor voltage is divided by the first resistor R1 and the second resistor R2 to enable the voltage dividing point 436 to have the first voltage. In some embodiments, the voltage divider 435 additionally includes a parallel capacitor 439, and the parallel capacitor 439 is connected in parallel to the second resistor R2.

Therefore, when the alternating current power supplier 20 normally supplies alternating current power, the first light receiving element 42b and the second light receiving element 44b are conducted by turns, and the capacitor 437 is maintained at a voltage level close to the direct current power 46. Therefore, a voltage of the voltage dividing point 436 (that is, a first voltage) is approximately the direct current power times R2, divided by R1 plus R2. When the alternating current power supplier 20 is powered off, and the luminous intensity of light emitted by the first or second light emitting element 42a or 44a, driven by discharging by the capacitor of the current limiting circuit 415, cannot make the corresponding first or second light receiving element 42b or 44b conduct, the capacitor 437 performs discharging from the first resistor R1 and the second resistor R2, so that the first voltage at the voltage dividing point 436 decreases. Therefore, the first voltage changes according to the power state of the alternating current power.

The level determining circuit 60 is electrically connected to the direct current power 46, and the level determining circuit 60 has a reference input end 452r, a reference voltage Vref, and an output end 452c. The level determining circuit 60 selectively outputs the abnormal signal at the output end 452c by comparing the first voltage with the reference voltage Vref. In some embodiments, the level determining circuit 60 may be, but is not limited to, a comparator circuit.

Referring to FIG. 2, the level determining circuit 60 includes a front resistor 454 and a comparing element 452. The front resistor 454 is connected in series to the comparing element 452, and the front resistor 454 and the comparing element 452 that are connected in series are connected in parallel between the direct current power 46 and a ground. The comparing element 452 compares the first voltage with the reference voltage Vref, and outputs a comparison result at a connection point (that is, the output end 452c) between the front resistor 454 and the comparing element 452. In some embodiments, the comparing element 452 is a voltage regulator having a reference voltage Vref. An end of the front resistor 454 is electrically connected to a cathode 452c of the comparing element 452, the other end of the front resistor 454 is electrically connected to the direct current power 46, an anode 452a of the comparing element 452 is grounded, and a reference input end 452r of the comparing element 452 is electrically connected to the voltage dividing point 436. When a voltage of the comparing element 452 at the voltage dividing point 436 is higher than the reference voltage Vref, the anode 452a and the cathode 452c are conducted. Therefore, a potential of the cathode 452c is essentially equal to a potential of the anode 452a. In this embodiment, a level of the cathode 452c is essentially grounded. In the foregoing, the comparing element 452 is operated in a saturated region and a cutoff region.

To follow the foregoing description on operation of the isolation circuit 410 and coupling circuit 430, when the alternating current power supplier 20 normally supplies the alternating current power, the first light receiving element 42b and the second light receiving element 44b are conducted by turns, the voltage of the voltage dividing point 436 (that is, the reference input end 452r) is approximately the direct current power times R2, divided by R1 plus R2. In some embodiments, the reference voltage Vref of the comparing element 452 is lower than the direct current power times R2, divided by R1 plus R2. Therefore, when the alternating current power supplier 20 normally supplies the alternating current power, the first voltage of the voltage dividing point 436 is higher than the reference voltage Vref, so that the comparing element 452 is conducted, and a voltage level of the cathode 452c is essentially equal to a voltage level of the anode 452a, that is, the voltage level of the cathode 452c is essentially grounded. Therefore, the external control circuit 50 can learn, by determining that the output end 452c is grounded, that the alternating current power supplier 20 normally supplies power. In other words, when the voltage level of the output end 452c is essentially grounded, the output end 452c “does not output an abnormal signal” as described above.

When the alternating current power supplier 20 is powered off, a voltage (that is, the first voltage) received by the reference input end 452r from the voltage dividing point 436 decreases over time. When the voltage of the reference input end 452r is lower than the reference voltage Vref, the comparing element 452 changes from being conducted to being not conducted. In this case, the voltage level of the output end 452c (that is, the cathode 452c) is essentially close to a voltage value of the direct current power 46. Therefore, the external control circuit 50 may learn, by determining the voltage level of the output end 452c, that the alternating current power supplier 20 is powered off. A voltage signal output by the output end 452c is the foregoing comparison result output by the level determining circuit 60. When the voltage signal is essentially grounded, that is, it indicates that the alternating current power supplier 20 normally supplies power, the comparison result is “not outputting an abnormal signal”. When the voltage signal is essentially a voltage value of the direct current power 46, that is, it indicates that the alternating current power supplier 20 abnormally supplies power (for example, stopping power supply or being powered off), the comparison result is “outputting abnormal signal”.

In some embodiments, to adjust a time from that the alternating current power supplier 20 is powered off to that the level determining circuit 60 sends the abnormal signal, the capacitance of the capacitor 437, the impedance of the first resistor R1, the impedance of the second resistor R2, and/or the capacitance of the parallel capacitor 439 may be adjusted.

The antiparallel connection recited in the present disclosure indicates that the anode of the first light emitting element 42a is electrically connected to the cathode of the second light emitting element 44a, and the cathode of the first light emitting element 42a is electrically connected to the anode of the second light emitting element 44a. The parallel connection recited in the present disclosure indicates that an emitter of the first light receiving element 42b is electrically connected to an emitter of the second light receiving element 44b, and a collector of the first light receiving element 42b is electrically connected to a collector of the second light receiving element 44b.

In conclusion, the power converter 10 according to one or more embodiments of the present disclosure may detect a power state of the alternating current power, and sends an abnormal signal to the external control circuit 50 when the power state is powered off, to help the external control circuit 50 perform preprocessing before a shutdown on a load or an external electronic device.

What is claimed is:

1. A power converter, comprising:
a primary-side circuit, having a first input end and a second input end, wherein the primary-side circuit is configured to receive and convert an alternating current (AC) power into a primary-side output;
a transformer circuit, configured to receive the primary-side output;
a detecting circuit, comprising:
a first isolation component, comprising a first light emitting element and a first light receiving element, wherein the first light receiving element is conducted when the first light emitting element is conducted, and the first light receiving element is not conducted when the first light emitting element is not conducted;
a second isolation component, comprising a second light emitting element and a second light receiving element, wherein the second light receiving element is conducted when the second light emitting element is conducted, the second light receiving element is not conducted when the second light emitting element is not conducted, the first light emitting element and the second light emitting element are connected together in parallel and in a reverse voltage direction between a first antiparallel connection point and a second antiparallel connection point, the first antiparallel connection point is electrically connected to the first input end, the first light receiving element and the second light receiving element are connected in parallel and in a same voltage direction between a first parallel connection point and a second parallel connection point, and the first parallel connection point is electrically connected to a direct current (DC) power;
a current limiting circuit, having two ends respectively electrically connected to the second antiparallel connection point and the second input end;
a voltage divider, having a first end, a voltage dividing point, and a second end, wherein the first end is electrically connected to the second parallel connection point; and
a capacitor, electrically connected to the first end of the voltage divider and the second end of the voltage divider, wherein the capacitor stores a capacitor voltage when the first light receiving element or the second light receiving element is conducted, and the capacitor releases the capacitor voltage and generates a first voltage between the voltage dividing point and the second end when the first light receiving element and the second light receiving element are not conducted; and
a level determining circuit, having a first contact, a reference voltage, and an output end, wherein the first contact receives the first voltage, and the level determining circuit compares the first voltage with the reference voltage to selectively output an abnormal signal from the output end.

2. The power converter according to claim 1, wherein the current limiting circuit comprises:
at least one resistor and at least one capacitor that are sequentially connected in series, wherein an end of the resistor is electrically connected to the second antiparallel connection point, and an end of the capacitor is electrically connected to the second input end.

3. The power converter according to claim 1, wherein the voltage divider comprises:
a first resistor and a second resistor that are sequentially connected in series, wherein the first resistor and the second resistor that are connected in series are connected in parallel to the capacitor.

4. The power converter according to claim 1, wherein the level determining circuit comprises:
a front resistor; and
a comparing element, wherein an end of the front resistor is connected to the direct current power, the other end of the front resistor is connected to the comparing element, wherein the comparing element enables the level determining circuit to output the abnormal signal when the first voltage is less than the reference voltage, and the comparing element enables the level determining circuit not to output the abnormal signal when the first voltage is not less than the reference voltage.

5. A power converter, comprising:
a primary-side circuit, having two input ends, the primary-side circuit configured to receive an alternating current power from the two input ends, and rectify the alternating current power to output a primary-side output;
a transformer circuit, configured to receive the primary-side output;
an isolation circuit, connected in parallel to the two input ends, configured to detect a power state of the alternating current power, wherein the isolation circuit transmits a conducting signal when the power state is powered on, and the isolation circuit does not transmit the conducting signal when the power state is powered off;
a coupling circuit, wherein when the isolation circuit transmits the conducting signal, the isolation circuit is optically coupled to the coupling circuit, to enable the coupling circuit to generate a capacitor voltage, and when the isolation circuit does not transmit the conducting signal, the isolation circuit is electrically isolated from the coupling circuit, to enable the coupling circuit to generate a first voltage by dividing the capacitor voltage; and
a level determining circuit, having a reference voltage, the level determining circuit configured to compare the first voltage with the reference voltage to selectively output an abnormal signal.

6. The power converter according to claim 5, wherein the isolation circuit comprises:
a first light emitting element; and
a second light emitting element, connected in parallel to the first light emitting element in a reverse voltage direction.

7. The power converter according to claim 6, wherein the coupling circuit comprises:
a first light receiving element, optically coupled to the first light emitting element, wherein the first light emitting element and the first light receiving element are integrated into a first isolation component;
a second light receiving element, connected in parallel to the first light receiving element in a same voltage direction, wherein the second light receiving element is optically coupled to the second light emitting element, and the second light emitting element and the second light receiving element are integrated into a second isolation component;
a capacitor, connected in series to the second light receiving element, configured to store the capacitor voltage; and
a voltage divider, configured to divide the capacitor voltage to generate the first voltage.

8. The power converter according to claim 5, wherein the level determining circuit comprises:
a front resistor; and
a comparing element, wherein an end of the front resistor is connected to a direct current power, the other end of the front resistor is connected to the comparing element, enabling the level determining circuit to output the abnormal signal when the first voltage is less than the reference voltage, and enabling the level determining circuit not to output the abnormal signal when the first voltage is not less than the reference voltage.
